(19) United States
(12) Patent Application Publication
(10) Pub. No.: US 2005/0182909 A1
(43) Pub. Date: Aug. 18, 2005

(54) Memory access control in an electronic apparatus

(75) Inventors: Marcus Volp, Karlsruhe (DE); William Orlando, Peynier (FR)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.A., Montrouge (FR)

(21) Appl. No.: 11/022,284

(22) Filed: Dec. 22, 2004

(30) Foreign Application Priority Data
Dec. 23, 2003 (FR) 03 15323

(51) Int. Cl. G06F 12/00

(52) U.S. Cl. 711/152

(57) ABSTRACT

A method of access control in an electronic apparatus comprising at least one device and a shared memory, external to the said devices, which are connected by at least one communication bus. In one embodiment, a memory access control unit receives an instruction for access to the memory. The validity of the received operation is verified. If it is valid, the operation is carried out. Otherwise, the operation is not executed and no corresponding signal or instruction is produced. In response to invalid read operations, dummy data may be returned. This “silent” blocking of the operation makes it possible to control devices with DMA capability.

### BACKGROUND OF THE INVENTION

1. Field of the Invention

The present invention relates in general to memory access management in electronic apparatus with a shared memory.

2. Description of the Related Art

Non-integrated electronic apparatus may have a main memory and one or more devices, which are capable of accessing the memory by being connected to the memory via at least one communication bus. Such devices are, for example, processors and/or devices having the capability of direct access to the memory, or DMA capability (standing for “Direct Memory Access”). The apparatus may in particular have an SMP architecture (standing for “Symmetric Multi-Processor”), that is to say it may comprise a plurality of devices which are processors.

An electronic apparatus may be a unitary wired apparatus, that is to say one formed by a set of elements (processors, peripheral controllers, DMA controllers, network cards, memories, etc.) with a certain physical and functional unity. Such an apparatus is for example a general-purpose computer, a decoder or “Set-Top Box”, a PDA (standing for “Personal Digital Assistant”), a mobile telephone, other portable wireless products, etc.

Document EP-A-1 271 327 discloses a method for operating a digital system having a plurality of resources which are connected to a shared memory. The method comprises the definition of a plurality of regions inside an address space of the memory. For at least some of the regions of the memory, access rights can be assigned to devices. The region of the memory which is affected by a request for access to the memory, coming from the plurality of devices, is identified. The device among these which has initiated the request for access to the memory is recognized. Whether or not the device recognized in this way has the access rights for the identified region is determined. Lastly, access to the identified region by the recognized resource is permitted if the latter has the access rights for the identified region.

According to such a method, however, the access request is terminated in the event that access rights are violated. Furthermore, the rights violation is signaled by sending a bus error in return, which allows the resource that initiated the access request to obtain information about the systems, the rights, etc.

Yet, terminating an access request which was initiated by a device that has DMA capability requires detailed knowledge of the hardware architecture of the DMA controller and that of the device. Furthermore, termination of the request presupposes that the instance causing the termination can control the devices directly, whereas some DMA controllers do not allow a DMA request to be terminated once it has been initiated.

What is more, if the access rights violation has resulted from an attempt to hack the electronic instrument, the bus error which is generated in the event of an access rights violation may allow a malicious third party to interpret the blocking of the access request with a view to generating a new access attempt.

### BRIEF SUMMARY OF THE INVENTION

In one aspect, the present disclosure relates to a method and a device for memory access control making it possible to manage the read or write operations in a memory, which may come from a plurality of devices that all have access to said memory.

An aspect of the invention provides a method of access control in an electronic apparatus comprising at least one device and a shared memory, external to the said devices, which are connected by at least one communication bus, the method comprising:
reception of an instruction corresponding to a read or write operation in the memory, which is initiated by an initiator device;
verification of the validity of the operation which is received;
execution of the reading or writing in the shared memory according to parameters of the operation which are received with the instruction, in response to a valid read or write operation, respectively;
non-execution of the writing without production of any corresponding signal or instruction, in response to an invalid write operation;
non-execution of the reading without production of any corresponding signal or instruction, with non-significant information being returned to the initiator device, in response to an invalid read operation.

The verification of the validity of the operation may comprise authentication of the initiator device and/or verification of the integrity of the operation which is received.

In another aspect, when the memory map of a memory comprises a plurality of regions, read access rights and write access rights can respectively be associated with each of the devices, the verification of the validity of the operation may, alternatively or in addition, comprise verification of the device's access rights for the region affected by the operation, on the one hand as a function of the nature of the operation which is received, and on the other hand as a function of parameters of the operation which are received with the instruction and which comprise an identifier of the initiator device and a memory address.

In another aspect, non-significant information (i.e., data which does not reveal the content of the memory) returned to an initiator device in response to an invalid read operation comprises a binary word of the same size as a memory word returned by a valid read operation, the said binary word comprising specific binary values, for example “0”s, or having the value NaTVal (“Not A Thing Value”).

As a variant, this non-significant information may comprise a binary word of the same size as a memory word returned by a valid read operation, the said binary word comprising random binary values.

Another aspect of the invention relates to a memory access control unit or MCU (standing for “Memory Control Unit”) comprising means for carrying out the methods described above.

In another aspect, a computer readable media contains instructions for causing a memory controller to: determine whether a request from a device to access a shared memory is a valid request; respond to a valid read request by executing the request; respond to a valid write request by executing the request; and respond to an invalid read request by returning non-significant information.

Another aspect of the invention relates to an electronic apparatus comprising a memory and a plurality of devices, which can access said memory via at least one communication bus, as well as a memory access control unit.

### BRIEF DESCRIPTION OF THE SEVERAL VIEWS OF THE DRAWINGS

Other characteristics and advantages of embodiments of the invention will also be found when reading the description which follows. This is purely illustrative and should be read with reference to the appended drawings, in which:

FIG. 1 is a block diagram illustrating an example of an electronic apparatus with SMP architecture to which embodiments of the method according to the present invention may be applied;

FIG. 2 is a block diagram of a memory access control unit according to one embodiment of the method of the present invention.

### DETAILED DESCRIPTION OF THE INVENTION

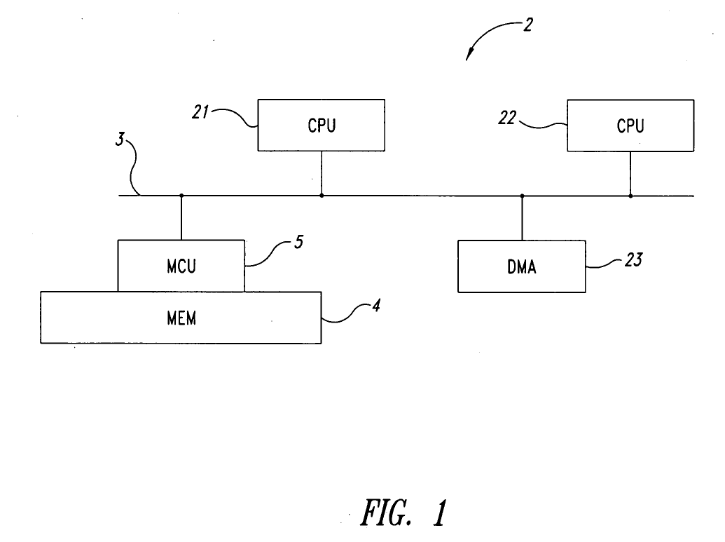

FIG. 1 shows an example of an electronic apparatus or system 2 to which embodiments of the method according to the present invention may be applied.

The apparatus 2 comprises a main memory 4 as well as at least one device, and in the general case a given number M of devices. The M devices are connected together by means of at least one communication bus 3. In general, the memory and the devices are connected by means of a bus comprising control lines, address lines, data lines, and other lines according to the requirements of the application. In the example represented in the figure, M is equal to 3 and the three devices are referenced 21, 22 and 23.

The memory 4 is for example a volatile memory with random access, or RAM (standing for “Random Access Memory”). The memory 4 is referred to as external in so far as it is outside the devices. It is furthermore referred to as shared in so far as it is intended to be accessed for reading and/or writing by a plurality of the given devices, or by all of them.

The devices 21 and 22 are for example processors (i.e., a CPU, standing for “Central Processing Unit”). The device 23 is for example a DMA controller. Such devices have in common the capability of accessing the memory 4 for reading and/or writing. Such devices may also have their own internal memories. At least some of the devices other than the DMA controller have the capability of sending DMA requests in order to obtain direct access to the memory. When there are a plurality of such devices, the DMA controller may be used to handle these DMA requests.

The architecture described above is referred to as SMP in so far as the electronic instrument comprises a plurality of processors and a shared memory 4, external to the processors, which are connected together by the bus 3.

The memory 4 is connected to the bus 3 by means of a memory access control unit 5 or MCU (standing for “Memory Control Unit”) which may carry out embodiments of the memory access control methods such as those described below.

In one exemplary embodiment, the MCU 5 manages a specific number N of separate regions of the memory map of the memory 4, which will be referred to as memory regions for brevity. In the example considered here, N is equal to 4 (N=4). The definition of the memory regions and the management of the access rights for the memory 4 are implemented in the MCU 5.

The various memory regions may overlap in pairs. However, the memory regions to which a given device has access, either for reading or for writing, are discrete (that is to say they do not overlap) in the memory map. Stated otherwise, in this embodiment a given device does not have access to overlapping regions of the memory map. This simplifies the management of the access rights which is carried out in the MCU 5.

Each of the memory regions is defined by two limiting addresses, namely a start address and an end address, respectively denoted for example by the letters sᵢ and eᵢ, for a memory region of index i, where i is an integer between 1 and N.

Privileges for each given memory region may be assigned selectively to each given device. These privileges may comprise a read access right (for reading from the said region), a write access right (for writing to the said region, and/or a modification right for modifying the access rights for reading and writing in said region and/or its limiting addresses sᵢ and eᵢ.

Access rights for reading and writing will be considered below. Conventionally, these access rights are respectively denoted by the letters rⱼ and wⱼ for a given device of index j, where j is an integer between 1 and M.

These rights are stored in an appropriate memory structure of the MCU 5, which comprises as many memory pages as there are regions. Each of these N memory pages comprises as many rows as there are devices whose access rights are managed by the MCU 5. These rows can be addressed by information corresponding to an identifier of the device.

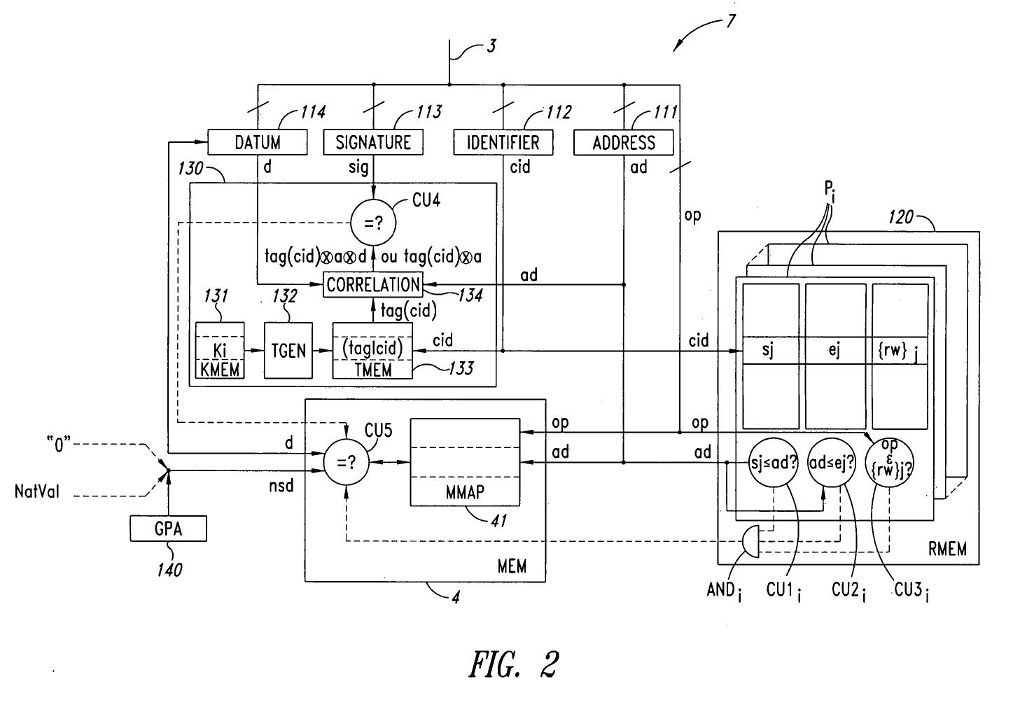

FIG. 2 gives the functional layout of an example controller 7 for carrying out embodiments of the memory access control method according to the present invention. All the elements of this controller 7 may be, for example, contained in the MCU 5 illustrated in FIG. 1.

The transmission of information on the bus 3 between the devices and the shared memory 4 is preferably a signed transmission. Stated otherwise, the interchanged information, and in particular the memory access instructions generated in the devices, are protected by a signature. A stream of binary tags, which are respectively used by each device in order to sign its memory access instructions, is generated in parallel both in the device and in the controller 7. The signature allows authentication of the initiator device and/or verification of the integrity of the instruction being transmitted by it on the communication bus.

When an instruction for read access or an instruction for write access in the memory 4 is initiated by any device, the controller 7 receives the following information from the bus 3 via respective lines of the bus intended for this purpose:
an address ad, which is placed in an input register referred to as the address register 111;
a device identifier cid, which is placed in an input register referred to as the identifier register 112;
optionally, a signature sig, which is placed in an input register referred to as the signature register 113; and,
optionally (that is to say when a write access instruction is involved), a datum d, which is placed in an input/output register referred to as the data register 114;
an operation code (“OP code”), which corresponds here to a read operation or write operation.

The address ad is the address in the shared memory 4 of the memory word which is affected by the operation.

The device identifier cid makes it possible to uniquely identify the initiator device, that is to say the one which initiated the instruction.

The signature sig may be calculated by the initiator device from the address ad and a binary tag, and optionally also from the datum d. The binary tag may be a binary word of specific size, generated for each instruction by segmenting a pseudo-random binary data stream which is produced by a pseudo-random function from an encryption key K specific to each device. The binary key is shared between the said device and the controller 7, that is to say it is known both by the device and by the controller 7.

The signature sig is, for example, information correlating the two information items ad and tag or the three information items ad, tag and d. This correlation is obtained, for example, by using a combination of the information in an exclusive-OR (XOR) operation. In other words, the signature sig is given respectively by the calculation:
sig=tag⊕ad (1)
or, when the operation is a write operation, by the calculation:
sig=tag⊕ad⊕d (2)

The sensitive information of the instruction, namely the address ad and optionally the datum d, are thus protected by the signature sig which is transmitted with the instruction. A malicious third party cannot therefore alter the address ad or the datum d being passed along the bus 3 without this alteration being detectable owing to the loss of correspondence with the signature sig of the data being transmitted.

In order to enhance security, the tag is used only once, that is to say for a single instruction. Stated otherwise, it changes value each time an instruction is initiated by the device in question.

In the controller 7, as described above, a region memory (RMEM) 120 comprises a memory page Pᵢ for each of the N memory regions defined in the memory map (MMAP) 41 of the memory 4, with i between 1 and N. Each memory page Pᵢ comprises M memory words, each containing the start address sᵢ and end address eᵢ of the memory region of index i, as well as all the rights {r,w}ⱼ assigned to the device of index j for this memory region. Each memory page Pᵢ of the region memory 120 can be addressed by the device identifier cid stored in the register 112.

For each memory region, the region memory 120 comprises three comparison units. Given that an operation is in progress, having been initiated by a device identified by the identifier cid and corresponding to the device of index j in the region memory, a first comparison unit CU1ᵢ has the task of comparing the address ad stored in the register 111 with the address sᵢ. A second comparison unit CU2ᵢ is used to compare the address ad with the address eᵢ. Lastly, a third comparison unit CU3ᵢ makes it possible to compare the OP code of the operation with all the rights {r,w}ⱼ assigned to the initiator device. If each of these comparison units produces a positive result, then the initiator device does indeed have the access right corresponding to the operation in progress, for the memory region in which the relevant address lies.

The controller 7 further comprises an authentication and integrity-verification module 130.

The module 130 comprises a key memory (KMEM) 131 in which the keys Kⱼ of each device are stored, for j between 1 and M. On the basis of the respective key Kⱼ of each device of index j, a tag generator (TGEN) 132 is capable of producing the next tag which is to be used by the device. The generator 132 comprises, for example, a pseudo-random generator (GPA) which generates a continuous stream of random data and is coupled to a segmentation unit which segments this stream so as to produce the tags of ad-hoc size.

The tags produced in this way are stored in a tag memory (TMEM) 133. It is advantageous during the processing of an operation in progress, which has been initiated by a given device, that the tag generator 132 produces the tag which will normally be used by this device for its next memory access operation. The tag produced in this way is stored until it is subsequently used, when processing the next operation of the same device. This speeds up the processing of the memory access operations.

The tag memory 133 is addressed by the device identifier cid stored in the register 112. This makes it possible to provide a tag tag(cid) to a correlation module 134. The tag tag(cid) corresponds to the binary word which the initiator device has used in order to generate the signature sig stored in the register REG_sig.

The module 134 also receives the address ad stored in the register 111, and optionally the datum d stored in the register 114. The function of the module 134 is to carry out calculation (1) or calculation (2), as indicated above, inside the controller 7 on the basis of the information available in the controller 7. Stated otherwise, the module 134 calculates the signature expected by the controller 7 for the operation in progress.

The result produced by the module 134 is compared by a comparison unit CU4 with the signature sig stored in the register 113. If they are the same, this means that the information being transmitted on the bus 3 does indeed come from the device whose identifier cid was received, and also that it has not been corrupted. Stated otherwise, this means that authentication of the initiator device and verification of the information being transmitted on the bus have been successful.

The shared memory 4 comprises a memory map (MMAP) 41 and a comparison unit CU5. The memory map MMAP is addressed by the address ad stored in the register 111.

The unit CU5 receives as input a first information item indicating whether the results of the comparisons carried out by the three comparison units CU1ᵢ, CU2ᵢ and CU3ᵢ are simultaneously positive, for any one of the memory pages Pᵢ of the region memory RMEM. In practice, this first information item may be, for example, obtained by combining the results of the three comparison units CU1ᵢ, CU2ᵢ and CU3ᵢ, for i between 1 and N, in a logical operator of the AND type with three respective inputs ANDᵢ, then by combining the outputs of these N AND gates in a logical operator of the OR type with N inputs (this has not been represented for the sake of simplicity).

The unit CU5 further receives as input a second information item corresponding to the result of the comparison carried out by the unit CU4 of the module 130.

If the first and second information items are true, that is to say if the operation is valid in so far as the initiator device is authenticated, and the information received about the instruction has integrity, and also the device does actually have the access right corresponding to the operation op requested for the memory address ad in question, then the requested operation is carried out normally. Stated otherwise, the datum d is written to the memory map MMAP at the address ad when a write operation is involved, or data (also denoted by d in the figure for the sake of simplicity) is read from the memory map MMAP at the address a and is placed in the register 114 when a read operation is involved.

Otherwise, an invalid write operation will not be carried out. Stated otherwise, the value stored in the memory word of the memory 4 which has the address ad will not be modified. In response to an invalid read operation, it will not be the data stored in this memory word which is placed in the register 114 in order to be returned to the initiator device. Instead, it will be non-significant information nsd which is placed in the register 114 at the instigation of the unit CU5. In both cases (a write operation and a read operation), the controller 7 need not generate any signal associated with the blocking of the operation. Nor will it be necessary to generate any interrupt or other instruction as a consequence of this blocking.

This non-significant information nsd advantageously may comprise a binary word of the same size as a memory word which would be returned by a valid read operation.

The aforementioned binary word preferably has a random value produced by a generator 140, a sequence of random binary output values from which is segmented in order to form such a binary word. Thus, the datum which the initiator device receives in return may be completely random. The requesting device cannot therefore even find out that it has been foiled by the controller 7. This is particularly advantageous in order to prevent hacking access attempts.

In both cases, that is to say for an invalid write operation and for an invalid read operation, the controller 7 is said to employ a “silent” blocking of the operation in so far as neither the initiator device nor the rest of the devices have any way of knowing that the operation has failed.

In one embodiment, the controller 7 operates in the following way. First, the controller 7 receives an instruction via the bus 3, which instruction corresponds to a read or write operation in the memory, which has been initiated by a specific initiator device. The instruction comprises parameters, namely an operation code op which indicates the nature (read or write) of the operation, an address ad in the memory map 41 of the memory 4, an identifier cid of the initiator device, optionally a data d to be written (in the case of a write operation), and a signature sig of the information being transmitted via the bus. Apart from the operation code op, these parameters are respectively stored in the input registers 111, 112 and 113 and in the input/output register 114.

Using the region memory 120, the validity of the operation specified in the received instruction is verified in respect of the access right of the initiator device to the memory region affected by the operation, that is to say the region of the memory map of the memory 4 comprising the address a. This verification is based, on the one hand, on the operation code op and, on the other hand, on the identifier cid of the initiator device and on the memory address ad. To this end, the parameters of the operation which have been received with the instruction are delivered to the input of the region memory 120.

As a variant or in addition, the authentication and/or integrity verification module 130 may be used in order to verify the validity of the operation specified in the received instruction in respect of the authenticity of the initiator device and/or in respect of the integrity of the command which is received. To this end, the address ad, the identifier cid, the signature sig and optionally the data d are delivered to the input of the module 130.

If the operation is valid, that is to say if one and optionally also the other of the aforementioned verifications gives a positive result, the operation is executed according to the parameters received with the instruction. These parameters are the address ad for a read operation, or the address ad and the data d for a write operation.

In response to an invalid write operation, the method provides for non-execution of the writing without production of any corresponding signal or instruction. In particular, no bus error is signaled and no interrupt is generated. Everything happens as if the writing in the memory had taken place normally.

In response to an invalid read operation, the method also provides for non-execution of the reading without production of any corresponding signal or instruction (as in the case of an invalid write operation). But the controller 7 also returns non-significant information nsd to the initiator device. To this end, a binary word of random value is placed in the input/output register 114 of the controller 7 in order to be returned to the initiator device.

In a first variant, the binary word returned in the event of an invalid read operation comprises a sequence of specific binary values, for example a sequence of “0”s. This variant leads to a controller 7 which is simpler and therefore more economical in terms of computing power and hence electricity consumption. It is therefore recommendable for applications in which the electronic circuit is battery-operated.

In another variant, the binary word which is returned may be the value NaTVal (“Not A Thing Value”) as defined in the document Intel® Itanium® Architecture Software Developer's Manual, Vol. 1, Version 2.1, October 2002, page 21 and Table 5-2 on page 78. The same advantages as with the aforementioned first variant are obtained. This second variant is useful in the case of an electronic instrument having an architecture which supports this value NaTVal, typically an instrument produced on a platform based on the Intel® Itanium® processor.

One working configuration in which some embodiments of the present invention has an advantageous effect is as follows. Assume that access to part of the memory is allocated at a particular time by the manager of the memory to a given device having DMA capability and is allocated for a particular length of time (for example 10 seconds). Assume that the device in question does not comply with its contract and engages in a DMA request which lasts longer, for example 20 seconds. In a conventional system, since it does not have access to the hardware of the device, the manager of the memory cannot validly use this part of the memory for 20 seconds because it is the device which is in fact controlling its content. In some embodiments of the invention, conversely, the manager of the memory can re-allocate this part of the memory after having revoked the corresponding access rights of the device. The DMA request will continue but, because of the “silent” blocking, the read operation will not be able to result in the reading of sensitive information, or the write operation will not be able to modify the content of the memory. Stated otherwise, the controller 7 according to some embodiments of the invention makes it possible to deny the DMA request of the device without requiring an appropriate instruction from the device which initiated it.

Another working configuration is the one in which a hacker device intercepts the instruction being transmitted on the bus, and modifies for example the address for a read access operation (for example in order to obtain access to a protected memory range in which sensitive information is stored) or modifies the data to be written by a write operation (in order to compromise the integrity of the information stored in the memory). The verification carried out by the module 130 will give a negative result, since the hacker device will not be able to generate the signature expected by the controller 7 for the modified data being transmitted on the bus. The requested operation will consequently not be carried out. Owing to the “silent” blocking of the operation, the hacker device will not even know that its attempt has failed. The task of a malicious person wishing to hack the electronic instrument therefore becomes substantially more difficult.

The term “computer-readable medium” as used herein refers to any medium that participates in providing instructions to a processor or controller, such as MCU 5 in FIG. 1 or controller 7 in FIG. 2, for execution. Such a medium may take many forms, including but not limited to, non-volatile media, volatile media, and transmission media. Non-volatile media includes, for example, hard, optical or magnetic disks. Volatile media includes dynamic memory. Transmission media includes coaxial cables, copper wire and fiber optics. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to a processor for execution. For example, the instructions may initially be carried on a magnetic disk of a remote computer. The remote computer can load the instructions into its dynamic memory and send the instructions over a telephone line using a modem. A modem local to computer system can receive the data on the telephone line and use an infrared transmitter to convert the data to an infrared signal. An infrared detector coupled to a system bus can receive the data carried in the infrared signal and place the data on system bus. The system bus carries the data to system memory, from which a processor retrieves and executes the instructions. The instructions received by system memory may optionally be stored on storage device either before or after execution by the processor.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method of access control in an electronic apparatus having at least one device and a shared memory, external to said devices, which are connected by at least one communication bus, the method comprising:
receiving an instruction corresponding to a read or write operation in the memory, which is initiated by an initiator device;
verifying a validity of the operation which is received;
executing the reading or writing in the shared memory according to parameters of the operation which are received with the instruction, respectively in response to a valid read or write operation;
not writing without production of any corresponding signal or instruction, in response to an invalid write operation; and
not reading without production of any corresponding signal or instruction, with non-significant information being returned to the initiator device, in response to an invalid read operation.

2. The method according to claim 1 wherein verifying the validity of the operation comprises at least one of authentication of the initiator device or verification of the integrity of the operation which is received.

3. The method according to claim 2 wherein the instruction is transmitted on the bus and is a signed transmission.

4. The method according to claim 1 wherein a memory map of the shared memory comprises a plurality of regions, read access rights and write access rights for which can respectively be associated with each of the devices, and wherein the verification of the validity of the operation comprises verification of the initiator device's access rights for the region affected by the operation as a function, on the one hand, of the nature of the operation which is received and, on the other hand, parameters of the operation which are received with the instruction and comprise an identifier of the initiator device and a memory address.

5. The method according to claim 4 wherein the regions of the memory map of the shared memory to which a device has access are discrete.

6. The method according to claim 1 wherein the non-significant information returned to the initiator device in response to an invalid read operation comprises a binary word of a same size as a memory word returned by a valid read operation, said binary word having a specific value.

7. The method according to claim 1 wherein the non-significant information returned to the initiator device in response to an invalid read operation comprises a binary word of the same size as a memory word returned by a valid read operation, said binary word having a random value.

8. A memory access control, comprising:
means for receiving an instruction from a device corresponding to an operation in a shared memory;
means for verifying a validity of the operation;
means for executing a valid operation; and
means for responding to an invalid operation.

9. The memory access control of claim 8 wherein the means for verifying the validity of the operation comprises at least one of means for verifying an authentication of the device or means for verifying an integrity of the operation.

10. The memory access control of claim 9 wherein the means for receiving an instruction comprises a bus and the means for verifying an authentication of the device comprises means for verifying a device signature.

11. The memory access control of claim 8 wherein the means for verifying a validity of the operation comprises means for verifying access rights to a region of the memory.

12. The memory access control of claim 8 wherein the means for verifying a validity of the operation comprises means for verifying a device signature.

13. The memory access control of claim 8 wherein the means for responding to an invalid operation comprises means for generating an invalid data output in response to an invalid read operation.

14. The memory access control of claim 8 wherein the means for responding to an invalid operation is configured to ignore an invalid write operation.

15. The memory access control of claim 8 wherein the shared memory is configured as a plurality of memory regions for which read access rights and write access rights for a device can be assigned.

16. The memory access control of claim 15 wherein the memory regions to which a device has access are discrete.

17. The memory access control of claim 8 wherein the means for responding to an invalid operation is configured to return non-significant information in response to an invalid read operation.

18. The memory access control of claim 17 wherein the non-significant information comprises a binary word of a size of a memory word returned by a valid read operation, said binary word having a specific value.

19. The memory access control of claim 17 wherein the non-significant information comprises a binary word of a size of a memory word returned by a valid read operation, said binary word having a random value.

20. A system, comprising:
a bus;
a memory access control communicatively coupled to the bus;
a shared memory communicatively coupled to the memory access control and to the bus; and
a device communicatively coupled to the bus, wherein the memory access control is configured to control access to the shared memory by the device and to respond to an invalid attempt to read from the shared memory by returning non-significant information to the device.

21. The system of claim 20 wherein the memory control comprises:
a region memory having a memory page for each memory region, each memory page containing address information and access information associated with a region of the shared memory.

22. The system of claim 20 wherein the memory control comprises a verification module to verify an identity associated with the device.

23. The system of claim 22 wherein the verification module comprises a tag generator, a tag memory and a comparison unit.

24. The system of claim 23 wherein the tag generator comprises a psuedo-random generator.

25. The system of claim 20 wherein the memory access control is configured to disregard an invalid write attempt.

26. The system of claim 20 wherein the non-significant information is a size corresponding to a size of a response to a valid read attempt.

27. A computer readable media containing instructions for causing a memory controller to:
determine whether a request from a device to access a shared memory is a valid request;
respond to a valid read request by executing the request;
respond to a valid write request by executing the request; and
respond to an invalid read request by returning non-significant information.

28. The computer readable media of claim 27 wherein the instructions cause the memory controller to ignore an invalid write request.

29. The computer readable media of claim 27 wherein the instructions cause the memory controller to verify an authenticity of a requesting device when determining whether a request is a valid request.

30. The computer readable media of claim 27 wherein the instructions cause the memory controller to verify an integrity of an operation when determining whether a request is a valid request.

31. The computer readable media of claim 27 wherein the instructions cause the memory controller to verify that a requesting device has access rights to a region of the memory when determining whether a request is a valid request.
